(19) United States
(12) Patent Application Publication
(10) Pub. No.: US 2026/0187632 A1
(43) Pub. Date: Jul. 2, 2026

(54) TRANSACTION CARDS WITH VERIFIABLE CREDENTIALS

(71) Applicants: American Express Travel Related Services Company, Inc., New York, NY (US); American Express Services Europe Limited, London (GB)

(72) Inventors: Ajay Babu Maddukuri, Phoenix, AZ (US); Manik Biswas, Burgess Hill (GB)

(21) Appl. No.: 19/003,402

(22) Filed: Dec. 27, 2024

(51) Int. Cl. G06Q 20/40

(52) U.S. Cl. CPC G06Q 20/401

(57) ABSTRACT

Disclosed are various embodiments for provisioning transaction cards, such as payment cards, with verifiable credentials. First, a computing device can detect a wireless data connection between the computing device and a transaction card. Then, the computing device can obtain a user consent to provision a verifiable credential representing the user onto the transaction card. Subsequently, the computing device can send the verifiable credential to an identity application installed on the transaction card over the wireless data connection.

### BACKGROUND

Many transactions require verification or authentication of one or more aspects of person's identity. For example, some retail transactions require that the purchaser be at least a minimum age. As another example, some retailers may require that the identity of the purchaser be confirmed prior to completion of the purchase in order to prevent fraudulent purchases, such as when someone uses a stolen credit card to make a high value purchase. Moreover, sometimes discounts are available to individuals based on their identity, such as discounts for students, teachers, first responders, children, senior citizens, etc.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a portion of the user experience in one of several embodiments of the present disclosure.

FIG. 2 is a drawing depicting a portion of the user experience in one of several embodiments of the present disclosure.

FIG. 3 is a drawing of a network environment according to various embodiments of the present disclosure.

FIG. 4 is a sequence diagram illustrating an example of interactions between the various components of the network environment of FIG. 3, according to various embodiments of the present disclosure.

FIG. 5 is a sequence diagram illustrating an example of interactions between the various components of the network environment of FIG. 3, according to various embodiments of the present disclosure.

### DETAILED DESCRIPTION

Disclosed are various approaches for integrating identity information into a payment instrument such as a transaction card (e.g., a debit, credit, or charge card). This could include one or more verifiable credentials or other secure identification mechanisms. As a result, a payment instrument such as a transaction card can be used both for the purpose of proving one's identity, or features of one's identity, in addition to making a payment in a transaction. Moreover, the identity information can be provisioned onto the payment instrument with a user's computing device (e.g., mobile phone, tablet, personal computer, etc.), thereby allowing a user to control which identity credentials or aspects of a user's identity can be made available to others.

Accordingly, various embodiments of the present disclosure provide a technical solution to streamline the payment process when the customer's identity has to be verified because the payment instrument can provide both a payment credential and proof of identity. For example, a user's payment card, when inserted into or tapped on a payment terminal, could provide the payment terminal with verifiable proof of the user's age (e.g., when purchasing an item that requires the user to be a minimum age) and also the payment instrument to be used for the purchase. This reduces the number of interactions between the user and the payment terminal, allowing a transaction to process more quickly and the payment terminal to process more transactions in a given period of time.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

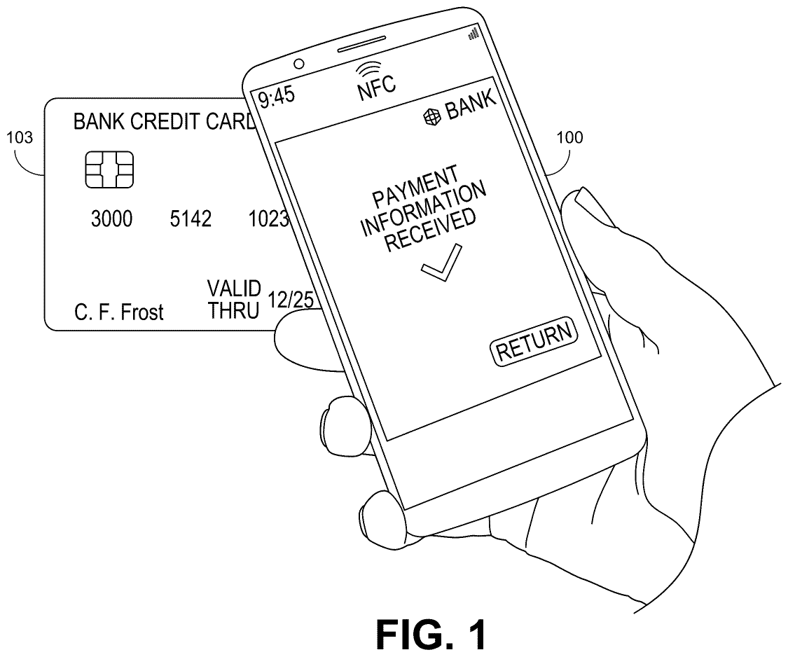

Beginning with FIG. 1, a user of a client device 100 could provision identification credentials on a payment instrument such as a transaction card 103 (e.g., a credit card, debit card, or charge card). For example, the user could use an application installed on the client device 100 to communicate with the transaction card 103 (e.g., via a near-field communication (NFC) or ultrawide band (UWB) connection). The application could write or store identification credentials on the transaction card 103, which could be used for future transactions.

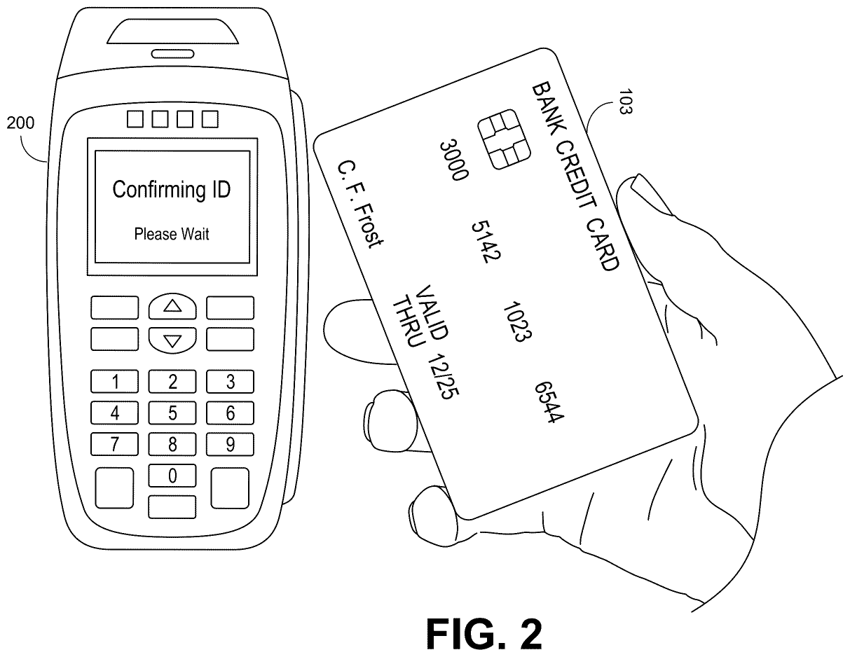

Moving on to FIG. 2, a user could tap his or her transaction card 103 on or insert his or her transaction card 103 into a payment terminal 200 in order to make a payment. As part of the payment process, the payment terminal 200 could request or otherwise receive the identification credentials stored on the transaction card 103 and use the identification credentials to process or verify the identity of the user. For example, the payment terminal 200 could use the identification credentials to determine if the user is eligible for any discounts (e.g., for students, teachers, first responders, senior citizens, children, or by virtue of membership to one or more other eligible groups). As another example, the payment terminal 200 could use the identification credentials to determine if the user is eligible to make the purchase (e.g., by rejecting the purchase if the identification credentials indicate that the user is under the legal age for the purposes of making the purchase).

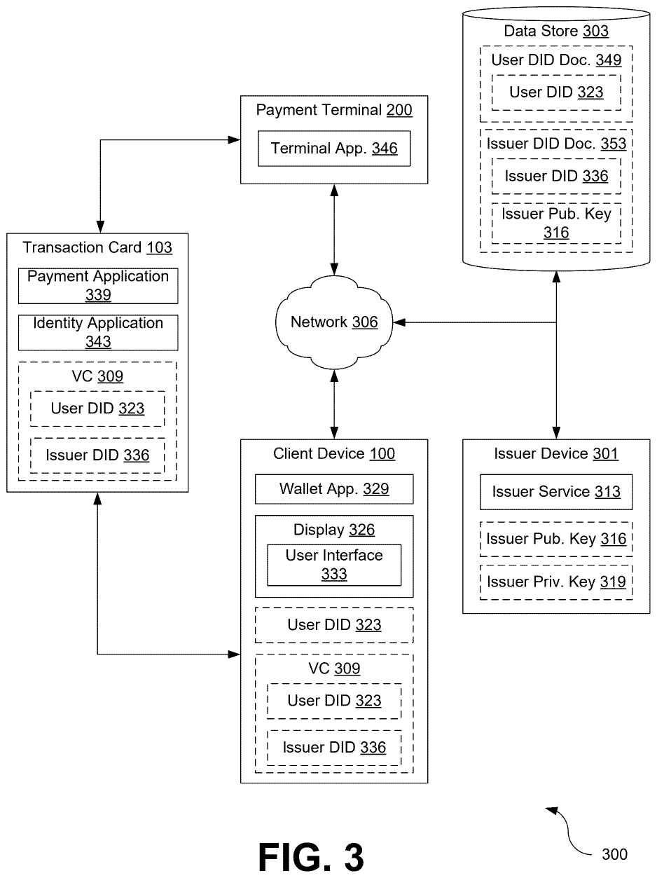

With reference to FIG. 3, shown is a network environment 300 according to various embodiments. The network environment 300 can include a client device 100, a transaction card 103, a payment terminal 200, an issuer device 301, and a data store 303. The client device 100, payment terminal 200, the issuer device 301, and the data store 303 can be in data communication with each other via a network 306. Separately, the transaction card 103 can be in direct data communication with the client device 100 and/or the payment terminal 200 when the transaction card 103 is in use according to various embodiments of the present disclosure.

The network 306 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 306 can also include a combination of two or more networks 306. Examples of networks 306 can include the Internet, intranets, extranets, virtual private networks (VPNs), and similar networks.

The issuer device 301 could be located within a computing environment. Such a computing environment could employ a plurality of computing devices that can be arranged in one or more server banks or computer banks or other arrangements. Such computing devices can be located in a single installation or can be distributed among many different geographical locations. For example, the computing environment can include a plurality of computing devices that together can include a hosted computing resource, a grid computing resource or any other distributed computing arrangement. In some cases, the computing environment can correspond to an elastic computing resource where the allotted capacity of processing, network, storage, or other computing-related resources can vary over time.

An issuer device 301 can represent one or more computing devices that are used to issue verifiable credentials 309. An issuer device 301 could be configured to host or execute an issuer service 313. An issuer device 301 could also store or have access to an issuer public key 316 and/or an issuer private key 319. The issuer device 301 and/or issuer service 313 could be operated by a variety of entities, including government agencies and corporate entities (e.g., financial institutions that issue credit, debit, and/or charge card products). For example, government agencies that are responsible for issuing government identification documents (e.g., driver's licenses, passports, etc.) could operate issuer devices 301 and/or issuer services 313 in order to issue verifiable credentials 309 to individuals. As another example, corporations that have extensive, verified knowledge about the identity of customers or individuals (e.g., data brokers, identity brokers, financial institutions, etc.) could operate issuer devices 301 and/or issuer services 313 in order to issue verifiable credentials 309 to individuals.

The issuer service 313 could be executed to respond to requests to issue verifiable credentials 309. For example, an issuer service 313 could receive a request to issue a verifiable credential 309 from a client device 100. The request could include a user decentralized identifier (DID) 323 for the verifiable credential 309 to be associated with and/or information identifying the user or individual associated with the user DID 323. In other embodiments, however, the issuer device 301 could generate a user DID 323 to identify the user to be associated with the verifiable credential 309. The issuer service 313 could then issue a verifiable credential 309 in response, which could be signed by the issuer private key 319 to allow third parties to determine the authenticity of the verifiable credential 309 by using the issuer public key 316.

The issuer public key 316 and the issuer private key 319 could be parts of a public-private or asymmetric cryptographic key-pair used by the issuer service 313 when issuing verifiable credentials 309. The issuer private key 319 could be used to sign any verifiable credentials 309 issued, allowing third parties to determine the authenticity of the verifiable credential 309. The issuer public key 316 could be provided to any third party that requested the issuer public key 316 in order to verify that a verifiable credential 309 signed by the issuer private key 319 is genuine. The issuer public key 316, or a fingerprint of the issuer public key 316 could also be used to uniquely identify an issuer device 301 or issuer service 313 with respect to other issuer devices 301 or issuer services 313.

A client device 100 is representative of one or more client devices 100 that can be coupled to the network 306. A client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. A client device 100 can include one or more displays 326, such as liquid crystal displays (LCDs), gas plasma-based flat panel displays, organic light emitting diode (OLED) displays, electrophoretic ink (“E-ink”) displays, projectors, or other types of display devices. In some instances, the display 326 can be a component of a client device 100 or can be connected to a client device 100 through a wired or wireless connection.

A client device 100 can be configured to execute various applications such as a wallet application 329. The wallet application 329 can represent any application that allows a user to manage his or her digital identity, including generating, issuing, or requesting User DIDs 323; requesting, obtaining, or sharing verifiable credentials 309; revoking or invalidating user DIDs 323 or verifiable credentials 309; etc. Accordingly, the wallet application 329 could cause a user interface 333 to be presented or shown on the display 326 of the client device 100 in order to obtain instructions or consent to perform various transactions on behalf of the user. The wallet application 329 could be a separate, standalone application or, in some implementations, could be an extension or plugin integrated into other applications.

A client device 100 could also store various types of data for use in the various embodiments of the present disclosure. For example, a client device 100 could store one or more user decentralized identifiers (DIDs) 323. A client device 100 could also store one or more verifiable credentials 309 linked to respective user DIDs 323.

A user decentralized identifier (DID) 323 can correspond to an identifier that enables a verifiable, decentralized digital identity for a subject (e.g., a person, organization, thing, etc.). For example, a user DID 323 can be used to represent the identity of a user, a computing device, or other objects. An individual can have multiple a user DID 323. For example, a user might use a first a user DID 323 to manage their work-related identity and a second a user DID 323 to manage their personal identity outside of work. In some implementations, the user DID 323 can be implemented using various standards, such as a version of the World Wide Web Consortium's (W3C's) Decentralized Identifier (DID) standard.

A verifiable credential 309 represents a credential issued by an issuer service 313 to the wallet application 329 of the user, which can store the verifiable credential 309 on the client device 100. Verifiable credentials 309 can be represented, for example, using JavaScript Object Notation (JSON) objects or files. A verifiable credential 309 can include various fields or data, such as the issuer DID 336 associated with the operator of the issuer service 313 that issued the verifiable credential 309, a user DID 323 associated with the subject of the verifiable credential 309, the type of credential (e.g., government issued identification, employee identification, education degree, attestation of identify by a non-government entity, etc.). Fields such as those representing the subject of the verifiable credential 309 could have a respective user DID 323 specified as the identifier of the subject. Similarly, fields such as those representing the issuer of the verifiable credential 309 could have a respective issuer DID 336 specified as the identifier of the issuer. In some implementations, verifiable credentials 309 could be implemented using a standard, such as a version of the W3C's “Verifiable Credentials Data Model.”

As previously mentioned, verifiable credentials could be issued in a number of contexts by various issuers, each of whom could operate their own, independent issuer device 301 and/or issuer service 313. For example, a verifiable credential 309 representing a driver's license, passport, birth certificate, or other government issued identification could be issued by a respective government entity to attest to the identity of the user, including data such as the full legal name, age, weight, height, eye color, and/or hair color of the user. As another example, a university could issue a verifiable credential 309 that represents a university degree awarded to the user, thereby providing verification of the identity of the user and verification that he or she holds a particular degree. In another example, an employer could issue a verification credential 309 that attests to the identity of the individual and his or her current employment status and/or role with within the company. In some situations, a third-party could issue their own verifiable credential 309 attesting to the identity of the user. For example, third-party data brokers or identity management services could issue a verifiable credential 309 that can make one or more claims about the identity of the user. Similarly, a bank, financial institution, or other entity that is required to validate or verify the identities of its users or customers (sometimes referred to as “know your customer” or “KYC”) could use its knowledge of their customers to issue verifiable credentials 309 to customers for them to present to others in order to verify their identities.

The transaction card 103 can represent any smart card (sometimes referred to as a chip card or integrated circuit card) that can be used for payments or otherwise completing a transaction for goods or services. For example, a transaction card 103 can include a microprocessor configured to execute one or more payment applications 339 as well as other applications such as an identity application 343. Examples of the microprocessor can include any chip that is compliant with a version of the Europay, Mastercard, and Visa (EMV) standard, sometimes referred to as an EMV chip. Although depicted separately, in some implementations, a payment application 339 and an identity application 343 could be implemented using a single application that can perform the functions of both.

A payment application 339 can be executed by the transaction card 103 to confirm or authorize a transaction made by a respective transaction card 103. Individual payment applications 339 can be provisioned on the chip of the transaction card 103 by issuers. For example, a financial institution could provision an EMV chip on a credit or debit card with separate payment applications 339 for a debit card rail and a credit card rail. Accordingly, each payment application 339 can include a payment application identifier and payment account data for a payment account associated with the transaction card 103 that contains the chip. When a payment is to be made using the transaction card 103, the payment application can generate a cryptogram to send with other data to terminal application 346 executing on a payment terminal 200 in order for the terminal application 346 to send a transaction authorization request to the issuer of the transaction card 103.

An identity application 343 can be executed by the transaction card 103 to manage one or more verifiable credentials 309 provisioned on the transaction card 103 by the wallet application 329. The identity application 343 can be executed to communication with the wallet application 329 to receive one or more verifiable credentials 309 and store them on the transaction card 103. The identity application 343 can also be executed to interact with the terminal application 346 to provide one or more verification credentials 309 to the terminal application 346 as part of a transaction upon request by the terminal application 346.

The payment terminal 200 can represent any physical, hosted, or virtual terminal that can interact with the payment card 203 and the EMV chip thereon to generate a cryptogram and/or a transaction authorization request, which can include the cryptogram. Payment terminal 200 may be referred to as point-of-sale (POS) terminals, credit card machines, card readers, or PIN pads. Examples of payment terminals 200 include readers that communicate with a mobile application on a mobile device (e.g., smartphone, tablet, etc.), portable payment terminals 200 (e.g., handheld credit card machines), and dedicated or standalone payment terminals 200 (e.g., countertop readers integrated with a cash register).

Accordingly, the payment terminal 200 can be configured to execute a terminal application 346 in various embodiments of the present disclosure. The terminal application 346 can be executed to perform various steps of an EMV transaction flow, such as selecting a payment application 339 for use with a transaction (including reading a list of available payment applications 339 from the chip of the transaction card 103 and/or prompting the purchaser or card holder to select a payment application 339 from the list of available payment applications 339); reading payment application 339 data, including any payment account data associated with the payment application 339; performing offline data authentication; performing cardholder verification; requesting a cryptogram from the payment application 339 (generated using the cryptogram generating key and/or application transaction counter (ATC) stored on the transaction card 103); performing online transaction authorization; etc.

The terminal application 346 can also be configured to interact with the identity application 343 installed on the transaction card 103 in order to verify or authenticate the identity of the user. For example, the terminal application 346 could be executed to request one or more verifiable credentials 309 installed on the transaction card 103 and verify the authenticity or validity of the verifiable credentials 309. Once verified, the terminal application 346 could then use the information contained within the verifiable credential 309 to authenticate or verify the identity of the user or to process the transaction based at least in part on the identity of the user.

The data store 303 can be representative of one or more data stores 303 that are available to and/or accessible by the issuer service 313, terminal application 346, and/or wallet application 329. A data store 303 can implemented using relational databases or non-relational databases such as object-oriented databases, hierarchical databases, hash tables or similar key-value data stores, append-only distributed ledgers (e.g., blockchain-based data stores), as well as other data storage applications or data structures. Moreover, combinations of these databases, data storage applications, and/or data structures may be used together to provide a single, logical, data store. The data stored in the data store 303 is associated with the operation of the various applications or functional entities described below. This data can include one or more user DID documents 349, one or more issuer DID documents 353, and potentially other data.

A DID document is a document which describes how to interact with the owner or subject of a DID. For example, the DID document can describe the mechanisms by which a subject of a DID can authenticate itself or prove its association with the DID. This can include identifying the cryptographic public keys corresponding to the cryptographic private keys held by the subject of a DID. In some implementations, the DID document can be implemented using various standards, such as a version of the W3C's Decentralized Identifier (DID) standard.

Accordingly, a user DID 323 could have a corresponding user DID document 349 and an issuer DID 336 could have a corresponding issuer DID document 353. The user DID document 349 could include the user DID 323 to allow the user DID document 349 to be found when searching the data store 303. Likewise, the issuer DID document 353 could include the issuer DID 336 to allow the issuer DID document 353 to be found when searching the data store 303. The issuer DID document 353 could also include the issuer public key 316, which could be used to validate verifiable credentials 309 issued by the issuer service 313 identified by or associated with the issuer DID 336.

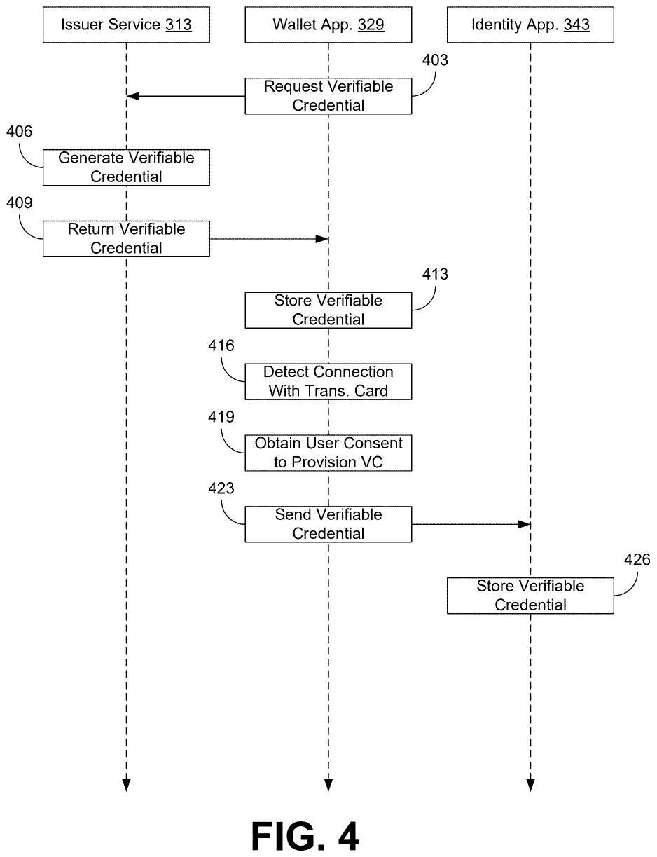

Referring next to FIG. 4, shown is a sequence diagram that provides one example of a portion of the operations of, as well as some of the interactions between the issuer service 313, the wallet application 329, and the identity application 343. The sequence diagram of FIG. 4 provides merely an example of the many different types of functional arrangements that can be employed to implement the operations of the depicted portion of the issuer service 313, the wallet application 329, and the identity application 343. As an alternative, the sequence diagram of FIG. 4 can be viewed as depicting an example of elements of a method implemented within the network environment 300.

Beginning with block 403, the wallet application 329 can send a request for a verifiable credential 309 to the issuer service 313. This could be done, for example, in response to the user interacting with the user interface 333 of the wallet application 329 to request the verifiable credential 309. The request can include information about the user (e.g., a user DID 323, a username or identifier, password, passkey, authentication token, etc.) that can allow the issuer service 313 to confirm the identity of the user and that the user has initiated the request instead of an impostor.

Accordingly, at block 406, the issuer service 313 can generate the requested verifiable credential 309 in response to confirming the identity of the user and that the user initiated the request. For example, the issuer service 313 could confirm that a user with a matching user identifier is known to the issuer service 313 (e.g., that a bank has a customer who matches the user identifier, an employer has an employee who matches the user identifier, that the government agency has an individual in its records who matches the user identifier, etc.). Then, the issuer service 313 could generate a verifiable credential 309. The verifiable credential 309 could include a user DID 323 (either provided by the wallet application 329 at block 403 or generated by the issuer service 313), the issuer DID 336 representing the issuer service 313, and information about the user (e.g., legal name, age, hair color, eye color, height, weight, employment status, employer, work address, personal address, customer status, etc.). The verifiable credential 309 could also be cryptographically signed by the issuer service 313 with the issuer private key 319 to prove that the issuer service 313 issued the verifiable credential 309 and to allow others to confirm that the verifiable credential has not been altered by a third-party after issuance.

Then, at block 409, the issuer service 313 can return the verifiable credential 309 generated at block 406 to the wallet application 329. In response, the wallet application 329 can store the verifiable credential 309 on the client device 100 for future use. In some implementations, the verifiable credential 309 can be stored by the wallet application 329 in a secure enclave or other secure storage area provided by the client device 100.

Subsequently, a user may wish to provision the verifiable credential 309 stored on the client device 100 on a transaction card 103. Accordingly, at block 416, the wallet application 329 could detect that the client device 100 and the transaction card 103 have established a direct connection with each other. For example, the transaction card 103 could have been placed within proximity of the client device 100, allowing a wireless radio (e.g., an NFC reader) to communicate with the chip installed on the transaction card 103 (e.g., via an NFC connection). The wallet application 329 could detect the establishment of this connection.

In response to detecting that a direct connection has been established with the transaction card 103, the wallet application 329 could prompt the user or otherwise obtain user consent to provision the verifiable credential 309 on the transaction card 103 at block 419. For example, the wallet application 329 could query the transaction card 103 to determine if there is an identity application 343 installed on the transaction card 103. If the wallet application 329 determines that there is an identity application 343 installed on the transaction card 103, then the wallet application 329 could open on the client device 100 and present a user interface 333 asking the user if he or she would like to provision a verifiable credential 309 on the card. In some instances, the user interface 333 could prompt the user to select a verifiable credential 309 from a list of verifiable credentials 309 stored on the client device 100. The wallet application 329 could then confirm the selection of the user and their desire to provision the verifiable credential 309 on the transaction card 103.

Once the user has selected a verifiable credential 309 and/or consented to the provisioning of a verifiable credential 309 onto the transaction card 103, the wallet application 329 can cause the verifiable credential 309 to be sent to the identity application 343 at block 423. For example, the wallet application 329 could create an NFC message that includes the verifiable credential 309 as a custom payload and one or more custom tags that act as instructions for the identity application 343.

In some implementations, the wallet application 329 and the identity application 343 could perform a security handshake or other mutual authentication or verification mechanism. This could be performed, for example, to prevent loading the verifiable credential 309 onto an untrusted or unauthorized transaction card 103 or to prevent the transaction card 103 from loading a verifiable credential 309 from an untrusted source. For example, the identity application 343 could have been pre-provisioned with a copy of the issuer public key 316. The identity application 343 could use the issuer public key 316 to verify the cryptographic signature of the verifiable credential 309. Similarly, the wallet application 329 could send a challenge to the identity application 343, which the identity application 343 could encrypt with the issuer public key 316 and return to the wallet application 329. The wallet application could send to the encrypted challenge to the issuer service 313 for decryption. If the decrypted challenge returned from the issuer service 313 matches the challenge provided by the wallet application to the identity application 343, then the wallet application could determine that the identity application 343 was deployed or released by an authorized party, such as the issuer.

Accordingly, at block 426, the identity application 343 can store the verifiable credential 309 it received on the transaction card 103. For example, the chip on the transaction card 103 could include an amount of writeable or programmable memory. The identity application 343 could write or otherwise store the verifiable credential 309 in this section of writeable or programmable memory.

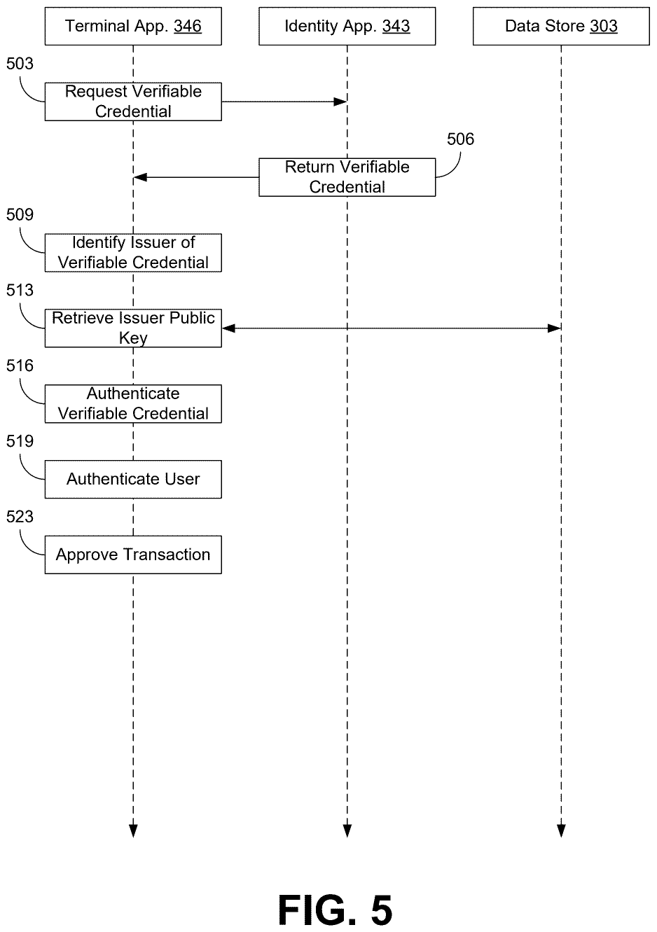

Referring next to FIG. 5, shown is a sequence diagram that provides one example of a portion of the operations of, as well as some of the interactions between, the terminal application 346, the identity application 343, and the data store 303. The sequence diagram of FIG. 5 provides merely an example of the many different types of functional arrangements that can be employed to implement the operations of the depicted portion of the terminal application 346, the identity application 343, and the data store 303. As an alternative, the sequence diagram of FIG. 5 can be viewed as depicting an example of elements of a method implemented within the network environment 300.

Beginning with block 503, the identity application could request a verifiable credential 309 from the identity application 343. This could happen as part of a transaction or payment process in response using his or her transaction card 103 with the payment terminal 200 to make a payment. As part of the payment flow or process, the terminal application 346 could send a request to the identity application 343 installed on the transaction card 103 for a verifiable credential 309. In some instances, the terminal application 346 could request all verifiable credentials 309 stored on the transaction card 103. In other instances, the terminal application 346 could request a verifiable credential 309 issued by a specific issuer, such as a trusted or preapproved issuer. In these situations, the terminal application 346 could provide the issuer DID 336 of the issuer service 313 of the issuer that is trusted or preferred by the terminal application 346.

Then, at block 506, the identity application 343 can return the requested verifiable credential 309. For example, the identity application 343 could return any or all verifiable credentials 309 stored on the transaction card 103 or one or more verifiable credentials 309 that match the parameters provided by the terminal application 346.

Subsequently, at block 509, the terminal application 346 can identify the issuer of the verifiable credential 309. For example, the terminal application 346 could evaluate or analyze the verifiable credential 309 to determine the issuer DID 336 for the issuer of the verifiable credential 309.

In response, at block 513, the terminal application 346 could obtain or retrieve the issuer public key 316 of the issuer of the verifiable credential 309. For example, the terminal application 346 could use the issuer DID 336 to search the data store 303 for an issuer DID document 353 with a matching issuer DID 336. The terminal application 346 could then retrieve or obtain the issuer public key 316 from the issuer DID document 353.

Then, at block 516, the terminal application 346 could verify or otherwise authenticate the integrity and source of the verifiable credential 309. For example, the terminal application 346 could use the issuer public key 316 retrieved at block 513 to verify the cryptographic signature of the verifiable credential 309 made with the corresponding issuer private key 319. If the cryptographic signature is valid, then verifiable credential 309 is authentic and unaltered.

Accordingly, at block 519, the terminal application 346 could then authenticate the user using the verifiable credential 309 based at least in part on the attributes specified by the verifiable credential 309. For example, if the transaction requires that a user be of a minimum age, or that the user gets a discount due to his or her age, then the terminal application 346 could use the verifiable credential 309 to determine the age of the user and whether the user is permitted to complete the transaction or is entitled to a discount. As another example, if the user is entitled to a discount due to his or her membership in a group (e.g., student or educational discount, first-responder discount, employee discount, etc.), then the terminal application 346 could user the verifiable credential 309 to determine which groups the user is a member of, if any. Other verifications could be performed as desired using the verifiable credential 309.

Subsequently, at block 523, the terminal application 346 can approve and/or process the transaction. For example, if the terminal application 346 determined at block 519 that the user was at least the minimum age to proceed with the transaction, then the terminal application 346 could proceed with the transaction (or alternatively decline the transaction if the user was under the minimum age). As another example, if the terminal application 346 determined at block 519 that the user was a member of a group eligible for a discount (e.g., student or educational discount, first-responder or government discount, employee discount, etc.), then the terminal application 346 could apply the discount to the transaction before proceeding to complete the transaction.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
detect a wireless data connection between the computing device and a transaction card;
obtain a user consent to provision a verifiable credential representing a user identification credential onto the transaction card via a user interacting with the computing device, the verifiable credential comprising at least one or more pieces of user identity information corresponding to one or more user attributes; and
send the verifiable credential to an identity application installed on the transaction card over the wireless data connection.

2. The system of claim 1, wherein the machine-readable instructions further cause the computing device to at least:
perform a security handshake with the identity application; and
the verifiable credential is sent to the identity application in response to a successful security handshake.

3. The system of claim 2, wherein the machine-readable instructions that cause the computing device to perform the security handshake further cause the computing device to:
send a challenge to the identity application;
receive an encrypted challenge from the identity application in response;
send the encrypted challenge to an issuer service;
receive a decrypted version of the encrypted challenge from the issuer service; and
determine whether the challenge sent to the identity application matches the decrypted version of the encrypted challenge received from the issuer service.

4. The system of claim 1, wherein the machine-readable instructions further cause the computing device, prior to detection of the wireless data connection, to at least:
send a request for a verifiable credential to an issuer service; and
receive a verifiable credential from the issuer service.

5. The system of claim 4, wherein the request for the verifiable credential that is sent to the issuer service includes a user decentralized identifier (DID) stored on the computing device.

6. The system of claim 1, wherein the verifiable credential is one of a plurality of verifiable credentials stored on the computing device and the machine-readable instructions that cause the computing device to obtain the user consent to provision the verifiable credential representing the user onto the transaction card further cause the computing device to at least:
present within a user interface the plurality of verifiable credentials; and
obtain a selection through the user interface of the verifiable credential from the plurality of verifiable credentials.

7. The system of claim 1, wherein the user identification credential comprises at least one of: a government issued identification, a university issued identification, or an employer issued identification.

8. A method, comprising:
detecting a wireless data connection between a computing device and a transaction card;
obtaining a user consent to provision a verifiable credential representing a user identification credential onto the transaction card via a user interacting with the computing device, the verifiable credential comprising at least one or more pieces of user identity information corresponding to one or more user attributes; and
sending the verifiable credential to an identity application installed on the transaction card over the wireless data connection.

9. The method of claim 8, further comprising:
performing a security handshake with the identity application; and
the verifiable credential is sent to the identity application in response to a successful security handshake.

10. The method of claim 9, wherein performing the security handshake further comprises:
sending a challenge to the identity application;
receiving an encrypted challenge from the identity application in response;
sending the encrypted challenge to an issuer service;
receiving a decrypted version of the encrypted challenge from the issuer service; and
determining whether the challenge sent to the identity application matches the decrypted version of the encrypted challenge received from the issuer service.

11. The method of claim 8, wherein, prior to detection of the wireless data connection, the method further comprises:
sending a request for a verifiable credential to an issuer service; and
receiving a verifiable credential from the issuer service.

12. The method of claim 11, wherein the request for the verifiable credential that is sent to the issuer service includes a user decentralized identifier (DID) stored on the computing device.

13. The method of claim 8, wherein the verifiable credential is one of a plurality of verifiable credentials stored on the computing device and obtaining the user consent to provision the verifiable credential representing the user onto the transaction card further comprises:
presenting within a user interface the plurality of verifiable credentials; and
obtaining a selection through the user interface of the verifiable credential from the plurality of verifiable credentials.

14. The method of claim 8, wherein the user identification credential comprises at least one of: a government issued identification, a university issued identification, or an employer issued identification.

15. A non-transitory, computer-readable medium comprising machine-readable instructions that, when executed by a processor of a computing device, cause the computing device to at least:
detect a wireless data connection between the computing device and a transaction card;
obtain a user consent to provision a verifiable credential representing a user identification credential onto the transaction card via a user interacting with the computing device, the verifiable credential comprising at least one or more pieces of user identity information corresponding to one or more user attributes; and
send the verifiable credential to an identity application installed on the transaction card over the wireless data connection.

16. The non-transitory, computer-readable medium of claim 15, wherein the machine-readable instructions further cause the computing device to at least:
perform a security handshake with the identity application; and
the verifiable credential is sent to the identity application in response to a successful security handshake.

17. The non-transitory, computer-readable medium of claim 16, wherein the machine-readable instructions that cause the computing device to perform the security handshake further cause the computing device to:
send a challenge to the identity application;
receive an encrypted challenge from the identity application in response;
send the encrypted challenge to an issuer service;
receive a decrypted version of the encrypted challenge from the issuer service; and
determine whether the challenge sent to the identity application matches the decrypted version of the encrypted challenge received from the issuer service.

18. The non-transitory, computer-readable medium of claim 15, wherein the machine-readable instructions further cause the computing device, prior to detection of the wireless data connection, to at least:
send a request for a verifiable credential to an issuer service; and
receive a verifiable credential from the issuer service.

19. The non-transitory, computer-readable medium of claim 18, wherein the request for the verifiable credential that is sent to the issuer service includes a user decentralized identifier (DID) stored on the computing device.

20. The non-transitory, computer-readable medium of claim 15, wherein the user identification credential comprises at least one of: a government issued identification, a university issued identification, or an employer issued identification.
